(19) United States
(12) Patent Application Publication
(10) Pub. No.: US 2026/0203643 A1
(43) Pub. Date: Jul. 16, 2026

(54) Inference Acceleration of a Model using an In-Place Mixture-of-Experts

(71) Applicant: Microsoft Technology Licensing, LLC, Redmond, WA (US)

(72) Inventors: Tianyi CHEN, Kenmore, WA (US); Tianyu DING, Redmond, WA (US); Luming LIANG, Redmond, WA (US); Ilya Dmitriyevich ZHARKOV, Niwot, CO (US)

(73) Assignee: Microsoft Technology Licensing, LLC, Redmond, WA (US)

(21) Appl. No.: 19/019,234

(22) Filed: Jan. 13, 2025

(51) Int. Cl. G06N 20/00

(52) U.S. Cl. CPC G06N 20/00

(57) ABSTRACT

A technique transforms an original model into an in-place mixture-of-experts model. To accomplish this, the technique first identifies at least one group of subnetworks that have different task-processing capabilities. The subnetworks are associated with respective groups of parameters. The technique then produces a router-supplemented model that includes a router that is capable of selecting a subset of the subnetworks to be used in processing a particular instance of input information. The router determines when a particular subnetwork should be selected based on a combination of two score parts. A first score part is based on token-related hidden state information, and a second score part is based on an assessed saliency of the particular subnetwork. The technique then fine-tunes the router-supplemented model, to produce the mixture-of-experts model. In inference, the mixture-of-experts model selects among the group of subnetworks using the router in a resource-efficient and low-latency manner.

### BACKGROUND

Machine-trained models are now capable of producing accurate responses in a variety of applications. However, many models achieve their success by incorporating a relatively large number of machine-trained parameters—in some cases, hundreds of billions of parameters. The large number of parameters has the negative consequence of reducing the latency of some models. Further, models with a large number of parameters consume a significant amount of memory and computation-related resources when processing input queries. These drawbacks limit the types of applications and platforms that are capable of successfully running the models.

One approach for reducing the inference-stage consumption of resources of a model is the mixture-of-experts (MoE) strategy. This strategy involves selectively invoking some parts of the model when processing a particular query, but not other parts, thereby reducing the amount of processing that is performed when processing the query. The selectable parts are referred to as “experts.”

There are two types of MoE models, classical and in-place. In classical MoE models, the experts are dedicated components that have been explicitly added to an original model. For the case of in-place models, the selectable experts constitute inherent structures of the original model. In-place models are generally smaller and easier to train than classical models. There nevertheless remains room for improvement with respect to the accuracy, resource efficiency, and latency-related performance of existing in-place MoE techniques.

### SUMMARY

A technique is described herein for transforming an original model into an in-place mixture-of-experts (MoE) model. To accomplish this goal, the technique first identifies at least one group of subnetworks in the original model that have different task-processing capabilities. The technique then produces a router-supplemented model having a router that is capable of selecting a subset of the subnetworks to be used in processing a particular input query. The technique then fine-tunes the router-supplemented model, to produce the MoE model. In inference, the MoE model dynamically selects among the group of subnetworks when processing different input queries.

The router determines whether a particular subnetwork should be selected based on a combination of two score parts. A first score part is based on token-related hidden state information, and a second score part is based on an assessed saliency of the particular subnetwork. The token-related hidden state information describes the positions and values of tokens that have been processed in one or more previous states.

According to another illustrative aspect, the operation of identifying includes identifying zero-invariant groups of parameters, each group being associated with a selectable subnetwork. Zero-invariance requires that, when a group of parameters associated with a component of the original machine-trained model are set to zero, the component produces an output result of zero.

According to another illustrative aspect, the router generates a score for each selectable subnetwork that is a weighted combination of the first score part and the second score part.

According to another illustrative aspect, the router produces the first score part using a prediction neural network having low rank, meaning that it uses machine-trained weights of reduced dimensionality.

According to another illustrative aspect, the router produces the second score part by aggregating plural saliency measures produced by different techniques.

According to another illustrative aspect, the operation of fine-tuning involves successively increasing the role of the router as training proceeds.

The in-place mixture-of-experts model is technically advantageous because, during inference, it is capable of selectively invoking subsets of subnetworks in a low-latency and resource-efficient manner. The technique for producing the in-place mixture-of-experts model is also scalable because it is capable of being performed on many different types of machine-trained models. In other words, the technique is model-agnostic in nature.

The above-summarized technology can be implemented using various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows a mixture-of-experts (MoE)-generating system for generating a mixture-of-experts (MoE) model, and an inference system for applying the MoE model.

FIG. 2 shows an example of the operation of the MoE-generating system of FIG. 1.

FIG. 3 shows groups of parameters associated with parts of a language model, which are identified using the MoE-generating system of FIG. 1.

FIG. 4 shows an example of a MoE component produced by the MoE-generating system of FIG. 1, which uses a router to select a subset of subnetworks to be used to process input information.

FIG. 5 shows one implementation of the router of FIG. 4.

FIG. 6 shows an example of first scoring logic that produces a first score part in a scoring component provided by the router of FIG. 4.

FIG. 7 shows an example of a state-capturing component that is used in the first scoring logic of FIG. 6.

FIG. 8 shows an example of a predicting component that is used in the first scoring logic of FIG. 6.

FIG. 9 shows an example of second scoring logic that produces a second score part in the scoring component of FIG. 4.

FIG. 10 shows an illustrative process by which the MoE-generating component of FIG. 1 identifies groups of subnetworks associated with respective node groups.

FIG. 11 shows an example of the process of FIG. 10 as applied to a particular original model.

FIG. 12 shows a principle that governs the operation of a fine-tuning component, which is another part of the MoE-generating system of FIG. 1.

FIG. 13 shows a chart that summarizes the performance of a MoE model produced by the MoE-generating system of FIG. 1.

FIG. 14 is a flowchart that describes one manner of operation of the MoE-generating system of FIG. 1.

FIG. 15 is a flowchart that describes one manner of operation of the inference system of FIG. 1.

FIG. 16 shows computing equipment that, in some implementations, is used to implement the systems of FIG. 1.

FIG. 17 shows an illustrative type of computing system that, in some implementations, is used to implement any aspect of the features shown in the foregoing drawings.

The same numbers are used throughout the disclosure and figures to reference like components and features.

### DETAILED DESCRIPTION

### A. Overview

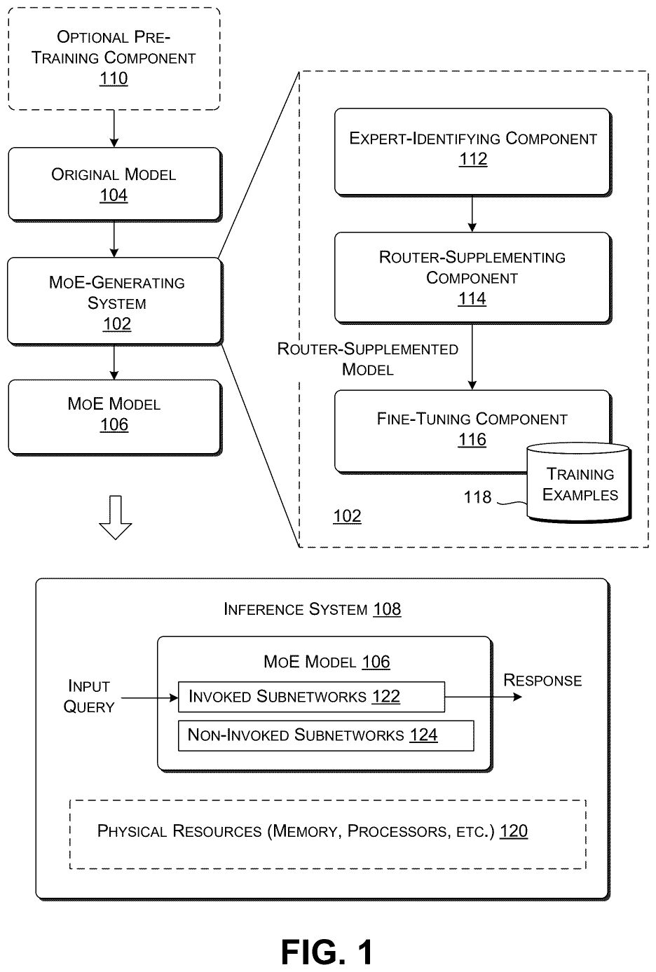

FIG. 1 shows a mixture-of-expert-generating system 102 for transforming an original model 104 into a mixture-of-experts machine-trained model 106. “Mixture-of-experts” is abbreviated as “MoE” herein, and “machine-trained model” is abbreviated as “model.” FIG. 1 also shows an inference system 108 for applying the MoE model. The MoE model is a kind of in-place MoE model because it includes one or more routers that route instances of input information to parts of the original model 104. In contrast, a classical MoE model adds replicated structures to the original model 104 and relies on one or more routers to route instances of input information to these replicated structures.

The MoE-generating system 102 is agnostic to the type of original model 104 that it operates on. This means that the MoE-generating system 102 is capable of operating on many different types of original models. In contrast, other MoE strategies are focused on creating experts for specific types of layers in specific types of machine-trained models. The model-agnostic nature of the MoE-generating system 102 contributes to its scalability.

Examples are presented herein for the case in which the original model 104 is a multi-layer neural network, such as a transformer-based language model. An optional pre-training component 110 initializes the weights of the original model 104. In some examples, the pre-training of a generative language model includes unsupervised training using language modeling (e.g., predicting the next word in a given text passage and comparing the prediction with the actual next word) and supervised training (e.g., predicting an output result and comparing the prediction with a ground-truth result). Background on the general task of pre-training generative language models is provided in Radford, et al., “Improving Language Understanding by Generative Pre-training,” OpenAI, San Francisco California, Jun. 11, 2018, 12 pages. One example of a publicly available pre-trained language model is described in Touvron, et al., “LLaMA: Open and Efficient Foundation Language Models,” arXiv, arXiv: 2302.13971v1 [cs.CL], Feb. 27, 2023, 27 pages.

In some implementations, the parameters of the original model 104 remain fixed in the course of transforming the original model 104 into the MoE model 106. In other implementations, the parameters of the original model 104 can be fine-tuned along with the router functionality (to be described below) added to the original model 104.

In some implementations, the MoE-generating system 102 produces the MoE model 106 in three main phases. An expert-identifying component 112 first identifies subnetworks of the original model 104 that are capable of serving as experts. A subnetwork refers to a group of parameters that is associated with a particular part (“model part”) of the original model 104. As such, the terms “subnetwork,” “parameter group,” and “expert” are used interchangeably herein. A parameter refers to any variable that is trainable in a training process. Examples of parameters include filter weights (W), bias variables (b), etc.

Section C provides a description of one manner of operation of the expert-identifying component 112. By way of preview, the expert-identifying component 112 converts the original model 104 into a directed graph. The directed graph incudes nodes that represent components of the original model 104 and edges that represent connections among the components. The expert-identifying component 112 then identifies node groups based on the directed graph, each of which represents a group of one or more functionally dependent components. The expert-identifying component 112 then identifies one or more parameter groups, as guided by the node groups that have been identified.

In some examples, each parameter group is characterized as being a removal structure. A removal structure is a kind of structure that is capable of being removed from the original model 104 without affecting the functions performed by remaining subnetworks of the original model 104. Stated in the negative, a structure does not qualify as a removal structure if its removal disables one or more functions performed by remaining subnetworks in the original model 104.

A specific kind of removal structure is a zero-invariant structure. A parameter group is said to be zero-invariant if, by setting all of its parameters to zero, an output result of a model part associated with the parameter group will also be zero. A zero-invariant structure is said to be minimal if it cannot be decomposed into smaller zero-invariant structures that satisfy the above constraints.

A router-supplementing component 114 adds a router to each set of node group identified by the expert-identifying component 112, to produce a MoE component. Each router assigned to a node group serves the purpose of routing an instance of input information fed to node group to a subset of the subnetworks (experts) associated with the node group. Section B provides further information regarding an illustrative implementation of a router. The end result of the router-supplementing component 114 is a router-supplemented model.

A fine-tuning component 116 performs fine-tuning on the router-supplemented model by processing training examples in a data store 118. This operation yields the MoE model 106. As stated above, in some implementations, the fine-tuning component 116 trains the weights associated with the added routing functionality, while keeping the parameters of the original model 104 fixed. In other words, the fine-tuning component 116 treats the added routing functionality as learnable adaptors added to the original model 102 having fixed weights.

In some implementations, the fine-tuning component 116 progressively phases in the role of the routers in the MoE model 106. For example, at the outset of fine-tuning, the fine-tuning component 116 invokes all of the subnetworks when processing input queries. The routers become more selective as training proceeds, e.g., by excluding an increasing number of subnetworks when processing queries. Section D provides further information regarding some implementations of the fine-tuning component 116.

The inference system 108 executes any application that applies the MoE model 106. For example, the inference system 108 represents a local system that runs the MoE model 106 without interaction with server-side functionality. Alternatively, the inference system 108 represents a server system that performs all the functions of the MoE model 106. Here, a user may interact with the server system via a local device, which is connected to the server system via a computing network. Alternatively, the inference system 108 implements some functions of the MoE model 106 using local resources and other functions of the MoE model 106 using server-side resources.

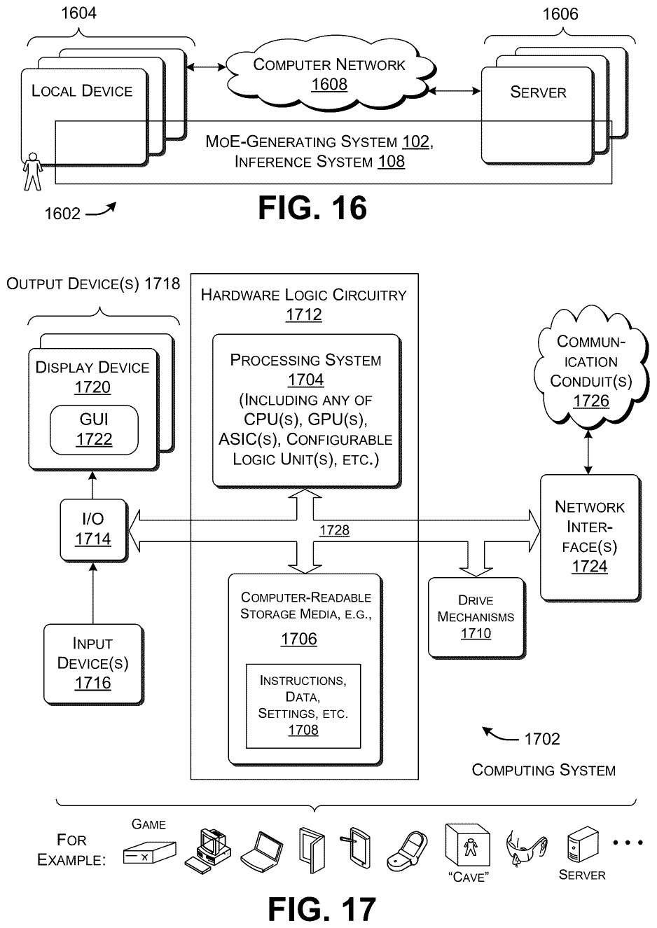

In general, FIG. 1 shows that the inference system 108 performs its functions using physical resources 120, including memory resources (e.g., random access memory) and computation-related resources (e.g., central processing units (CPUs), graphic processing units (GPUs), and/or neural processing units (NPUs)). In some contexts, terms such as “component,” “module,” “engine,” and “tool” refer to parts of computer-based technology that perform respective functions. FIGS. 16 and 17, described below, provide examples of illustrative computing equipment for performing these functions.

During inference, the MoE model 106 dynamically invokes different subsets of subnetworks (experts) to process different input queries. FIG. 1 summarizes this point by showing that, when processing a particular input query, the MoE model 106 invokes a subset of subnetworks 122. Another subset of subnetworks 124 are not invoked.

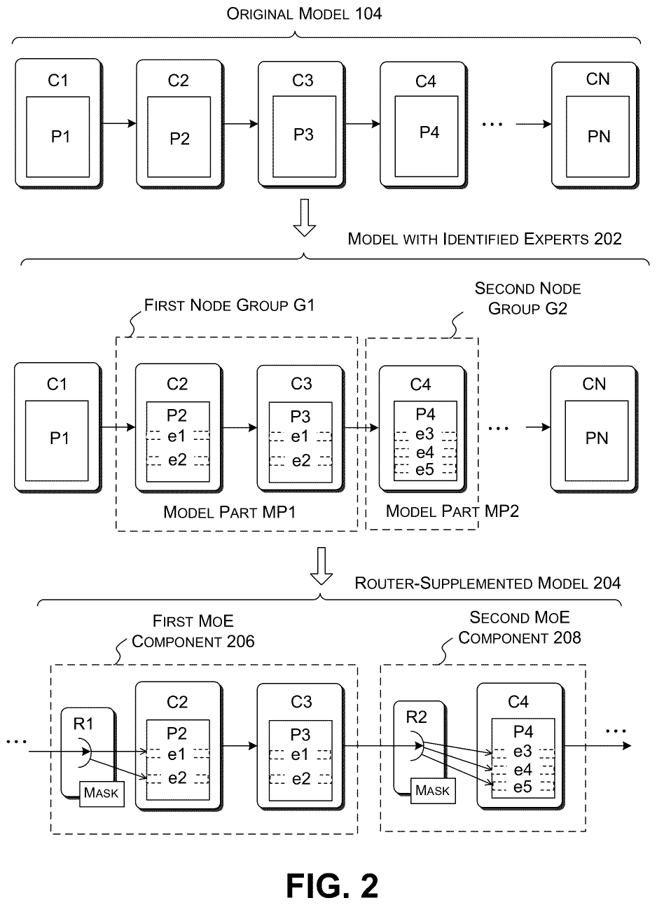

FIG. 2 shows a simplified and abstract example of the operation of the MoE-generating system 102 of FIG. 1. Assume that the original model 104 includes a sequence of model components (C1-CN) that perform functions based on corresponding sets of parameters (P1-PN). For example, the components are the successive layers of a convolutional neural network. FIG. 2 shows an example in which each component provides its output to a single next component (if any), but actual models can include more complex and varied connections among their layers (as will be shown in the example of FIG. 9).

The expert-identifying component 112 identifies at least two node groups (G1, G2). Each node group includes a functionally dependent set of components. For example, node group G1 is associated with components C2 and C2, while node group G2 is associated with just component C4. The expert-identifying component 112 also identifies one or more parameter groups associated with each node group. For example, the node group G1 is associated with parameter groups e1 and e2, while the node group G2 is associated with parameter groups e3, e4, and e5. For example, the parameter groups may correspond to rows of filter weights in filter matrices. As noted above, parameter groups correspond to respective subnetworks, and may also be referred to as experts.

The router-supplementing component 114 produces a router-supplemented model 204 by adding routers to each node group. More specifically, the router-supplementing component 114 adds a router R1 to node group G1, to produce a first MoE component 206, and adds a router R2 to node group G2, to produce a second MoE component 208. The first router R1 selects among experts e1 and e2 based on the input information fed to the first MoE component 206, while the second router R2 selects among experts e3-e5 based on input information fed to the second MoE component 208. Note that any number of experts are capable of being chosen at any given time. Overall, a Ratio parameter, described in Section B, governs the percentage of experts in a MoE component that are invoked in the processing of an input query. Note that FIG. 2 graphically represents the routers as performing a multiplexing function. While the routers achieve the same outcomes as switches, they perform their selecting functions by generating masks, and then by applying masks to the selectable subnetworks. This has the effect of zeroing out the contribution of non-selected subnetworks

The routers do not significantly add to the size of the original model 104, at least compared to the routing functionality added by other MoE strategies. For instance, the MoEBERT model (described below) achieves neuron-level routing using a resource-expensive hashing mechanism.

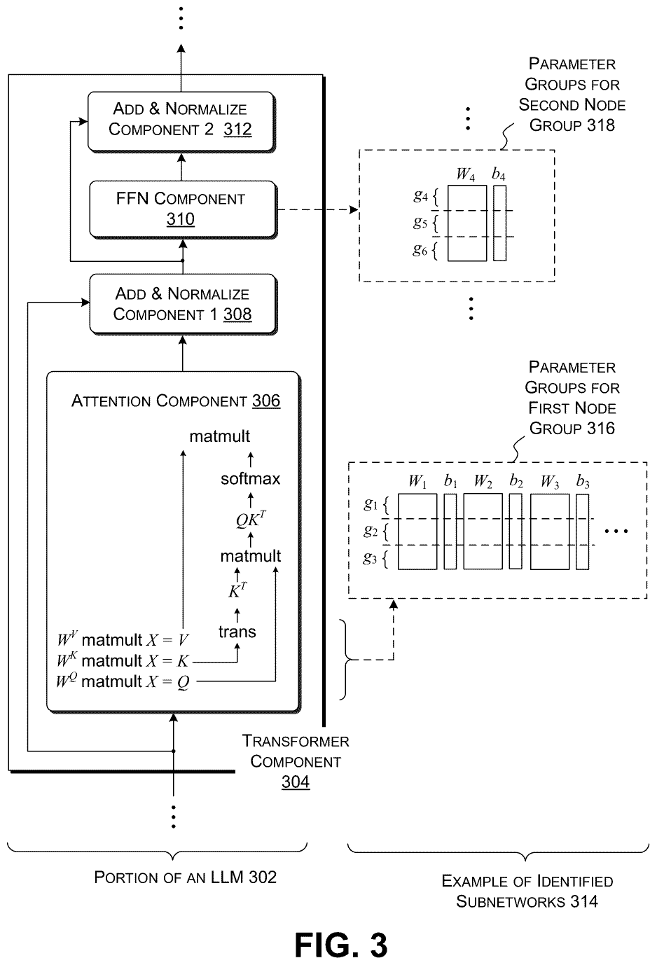

FIG. 3 shows a more concrete example of the operation of the expert-identifying component 112. Here, the original model 104 is a transformer-based language model (LLM), e.g., of the type described in Vaswani, et al., “Attention Is All You Need,” in 31st Conference on Neural Information Processing Systems (NIPS 2017), 2017, 11 pages. FIG. 3 shows a portion 302 of this language model, corresponding to a transformer block 304. The language model includes a series of transformer blocks (not shown) having the same construction as the transformer block 304. Each component of a block is associated with a set of parameters learned in a pretraining process.

The transformer block 304 includes, in order, an attention component 306, a first add-and-normalize component 308, a feed-forward neural network (FFN) component 310, and a second add-and-normalize component 312. The first transformer block in the series of transformer blocks receives position-supplemented input vectors produced by an encoder component (not shown), corresponding to tokens produced by a tokenizer (not shown). In some examples, a “token” refers to a unit of text having any granularity, such as an individual word, a word fragment produced by byte pair encoding (BPE), a character n-gram, a word fragment identified by the WordPiece or SentencePiece algorithm, etc. The principles set forth herein, however, are not limited to the processing of text information; in other examples, the language model operates on audio information, image information, video information, sensor information, and so on, or any combination thereof.

The attention component 306 determines how much emphasis should be placed on parts of input information when interpreting other parts of the input information. The attention component 306 performs attention analysis using the following equation:

$$Attention ( Q , K , V ) = softmax ( \frac{Q {K}^{T}}{\sqrt{{d}_{k}}} ) V . \qquad ( 1 )$$

The attention component 306 produces query information Q by multiplying the input information (X) by a query weighting matrix W^{Q}. Similarly, the attention component 306 produces key information K and value information V by multiplying X by a key weighting matrix W^{K} and a value weighting matrix W^{V}, respectively. To execute Equation (1), the attention component 908 takes the dot product of Q with the transpose of K, and then divides the dot product by a scaling factor \sqrt{d}, to produce a scaled result. The symbol d represents the dimensionality of Q and K. The attention component takes the Softmax (normalized exponential function) of the scaled result, and then multiplies the result of the Softmax operation by V, to produce attention output information. FIG. 3 summarizes the operations of Equation (1) in graphical form.

Although not shown, the attention component 306 may be composed of plural attention heads. Each attention head performs the computations specified by Equation (1), but with respect to a particular representational subspace that is different than the subspaces of the other attention heads. To accomplish this operation, the attention heads perform the computations described above using different respective sets of query, key, and value weight matrices.

The add-and-normalize component 308 includes a residual connection that combines (e.g., sums) input information fed to the attention component 908 with the output information generated by the attention component 306. The add-and-normalize component 308 then normalizes the output information generated by the residual connection, e.g., by layer-normalizing values in the output information based on the mean and standard deviation of those values, or by performing root-mean-squared normalization. The other add-and-normalize component 312 performs the same functions as the first-mentioned add-and-normalize component 308. The FFN component 310 transforms input information to output information using a feed-forward neural network having any number of layers.

The expert-identifying component 112 identifies node groups associated with the language model, and then identifies one or more parameter groups associated with these node groups. In aggregate, these parameter groups constitute groups of identified subnetworks 314. Assume, for instance, that the expert-identifying component 112 identifies a first node group 316 of subnetworks that play a role in the creation of the matrices Q, K, and V, as described above. For example, each subnetwork refers to one or more rows of filter weights in W^{Q}, W^{K}, and W^{V}. Assume that the expert-identifying component 112 identifies a second node group 318 of subnetworks that play a role in the matrix multiplication performed by the FFN component 310. For example, each subnetwork of the second node group refers one or more rows in the weight matrix used by the FFN component 310. Note that applying MoE components to different node groups will reduce computational costs by different respective amounts, depending on the functions that these node groups perform. In some implementations, a developer may choose to apply MoE components to only those node groups that will contribute a prescribed amount to the reduction in computational costs.

### B. Illustrative Router Implementations

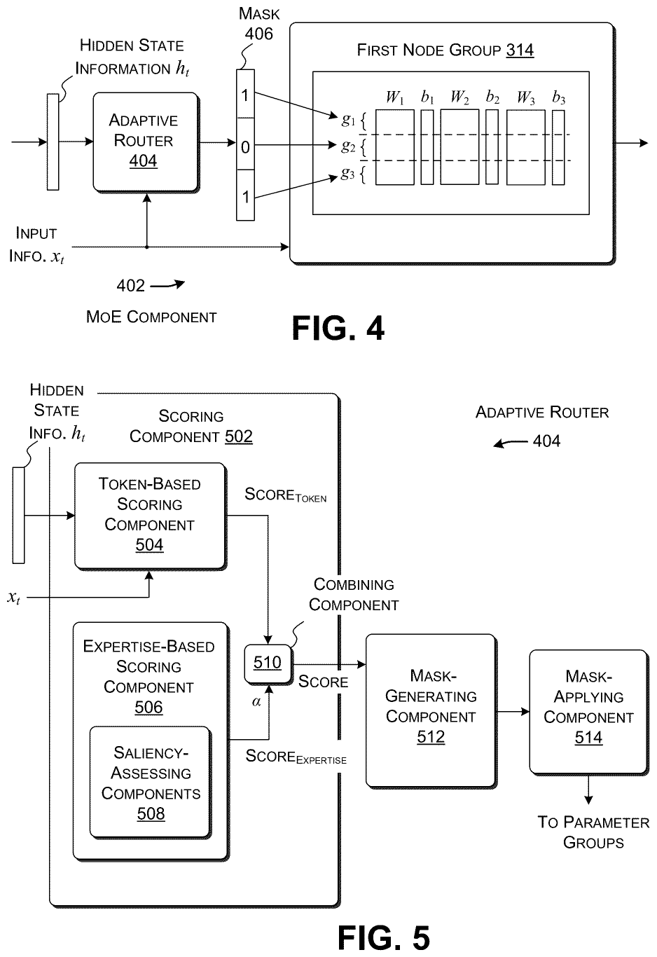

FIG. 4 shows an example of the operation of a MoE component 402. The MoE component 402 includes a router 404 that dynamically determines a subset of subnetworks to be invoked in the first node group 316 of FIG. 3 in the course of processing an input query. As previously explained, the first node group 316 includes parameters that govern part of the attention operation performed by the attention component 306. The router 404 receives an instance of input information xₜ that is provided by a previous layer of the language model (if any). The router 404 also receives hidden state information hₜ that the router has produced in a previous time stamp t−1. The router 404 will update this hidden state information, which will serve as input to the router 404 for the next time step (t+1).

The router 404 chooses K subnetworks in the first node group 316 and produces a mask 406 that expresses this selection. The router 404 then applies this mask 406 to the first node group 316, which has the effect of removing the contribution of the non-selected subnetworks, e.g., by zeroing out their contribution to an output result. As a result of this masking operation, the MoE component 402 will operate on the input information xₜ using only the K selected subnetworks.

FIG. 5 shows one implementation of the router 404 of FIG. 4. The router 404 includes a scoring component 502 that produces a score for each candidate subnetwork based on a weighted combination of a first score part (Scoreₜₒₖₑₙ) and a second score part (Scoreₑₓₚₑᵣₜᵢₛₑ).

A token-based scoring component 504 produces the first score part for a time stamp t based on input hidden state information hₜ and input information xₜ. As noted above, the hidden state information hₜ is produced by the router 404 in the previous time stamp (t−1). As a result, the hidden state information hₜ can be said to encapsulate historical information about prior-generated instances of hidden state information. Each instance of hidden state information can also be said to encapsulate information about tokens that have appeared in one or more instances of input information x. Such information includes information about the positions of the tokens, their values, etc.

An expertise-based scoring component 506 produces the second score part for each candidate subnetwork based on the attributes of the candidate subnetwork. The second score part generally reflects the importance or salience of the candidate subnetwork. The expertise-based scoring component 506 relies on information provided by one or more saliency-assessing components 508 to generate the second score part. The saliency-assessing components 508 measure the importance of the candidate subnetwork in different respective ways, examples of which are described below.

A combining component 510 forms the weighted combination of the first score part and the second score part, e.g., using:

$$Score = {Score}_{token} + α {Score}_{expterise} . \qquad ( 2 )$$

The weighting coefficient α controls the extent to which the second score part (Scoreₑₓₚₑᵣₜᵢₛₑ) contributes to the overall Score.

A mask-generating component 512 selects the top K subnetworks based on their respective scores, and then, for example, produces a mask that assigns a value of 1 to a selected subnetwork and a value of 0 to a non-selected subnetwork. The value of K is determined by multiplying a Ratio value by the number n of subnetworks associated with a node group under consideration (here, the first node group 316). For example, if there are 100 subnetworks, and Ratio is 60 percent, then K refers to the 60 subnetworks with the highest scores. A mask-applying component 514 applies the mask to the group of subnetworks, which has the effect of zeroing out the contribution of non-selected subnetworks in the course of processing the input information xₜ. In a first implementation, a single Ratio parameter applies to all MoE components in the MoE model 106. In a second implementation, different Ratio parameters apply to different respective MoE components.

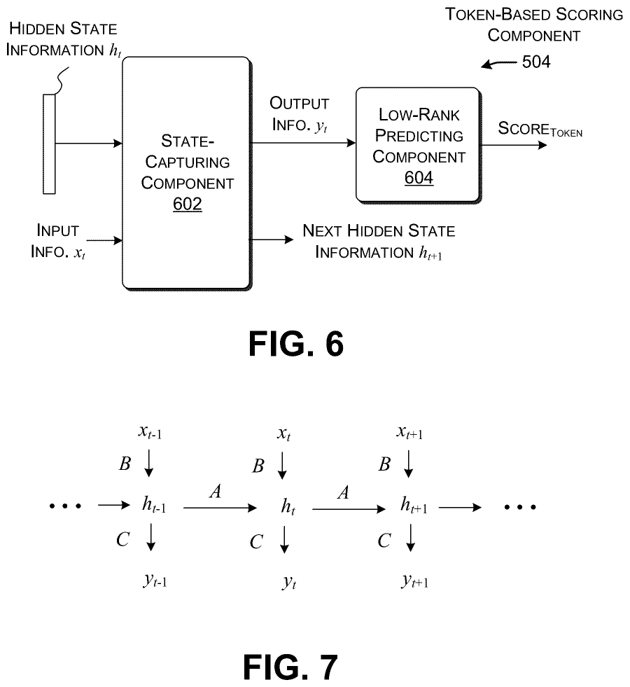

FIG. 6 shows one implementation of the token-based scoring component 504, which produces the first score part (Scoreₜₒₖₑₙ). The token-based scoring component 504 includes a state-capturing component 602 and a low-rank predicting component 604. The low-rank predicting component 604 operates on the output information (yₜ) produced by the state-capturing component 602, to produce the first score part (Scoreₜₒₖₑₙ). Mathematically, the operation of the token-based scoring component 504 is expressed as:

$${Score}_{token} = σ ( L ( R ( h ) ) ) . \qquad ( 3 )$$

In this equation, R(h) represents the function performed by the state-capturing component 602, L(·) represents the function performed by the low-rank predicting component 604, and σ is an activation function (e.g., the sigmoid function).

More specifically, the state-capturing component 602 maps an instance of input information xₜ and an instance of hidden state information hₜ for a time stamp t to an instance of output information yₜ and an updated instance of state information hₜ₊₁ for a next time stamp, t+1. The state-capturing component 602 is implemented using any kind of sequential model that operates on a sequence of hidden states, examples of which include recurrent neural network (RNNs), Long Short-Term Memory (LSTM) models, and selective state space models.

The low-rank predicting component 604 implements a linear function that involves mapping the output information yₜ to the first score part (Scoreₜₒₖₑₙ). The low-rank predicting component 604 uses one or more weight matrices that are purposely chosen to have a low rank. Rank refers to the dimensionality of the vectors in a weight matrix. In some implementations, a process produces each weight matrix such that its dimensionality satisfies a prescribed size target. Examples of processes for producing low-rank matrices include the LoRA technique (described in Hu, at al., “LoRA: Low-Rank Adaptation of Large Language Models,” arXiv, arXiv:2106.09685v2 [cs.CL], Oct. 16, 2021, 26 pages), singular value decomposition (SVD), principal component analysis (PCA), etc.

In some implementations, the state-capturing component 602 is implemented by a Mamba component, which is a particular type of selective state space model. FIG. 7 shows a succession of transformations performed by the Mamba component for three successive time steps. The transitions from one state to another are described by a state equation (h′(t)=Ah(t)+Bx(t)) and an output equation (y(t)=Ch(t)+Dx(t)). h(t) is the current hidden state information, h′(t) is updated hidden state information, x(t) is an instance of input information, y(t) is an instance of output information, and A, B, C, and D are learnable matrices that control the updating of the state and the generation of the output information. Information on the general topic of the Mamba model may be found at Gu, et al., “Mamba: Linear-Time Sequence Modeling with Selective State Spaces,” arXiv: 2312.00752v2 [cs.LG], May 31, 2024, 36 pages, and Qu, et al., “A Survey of Mamba,” arXiv, arXiv: 2408.01129v4 [cs.LG], Oct. 18, 2024, 39 pages.

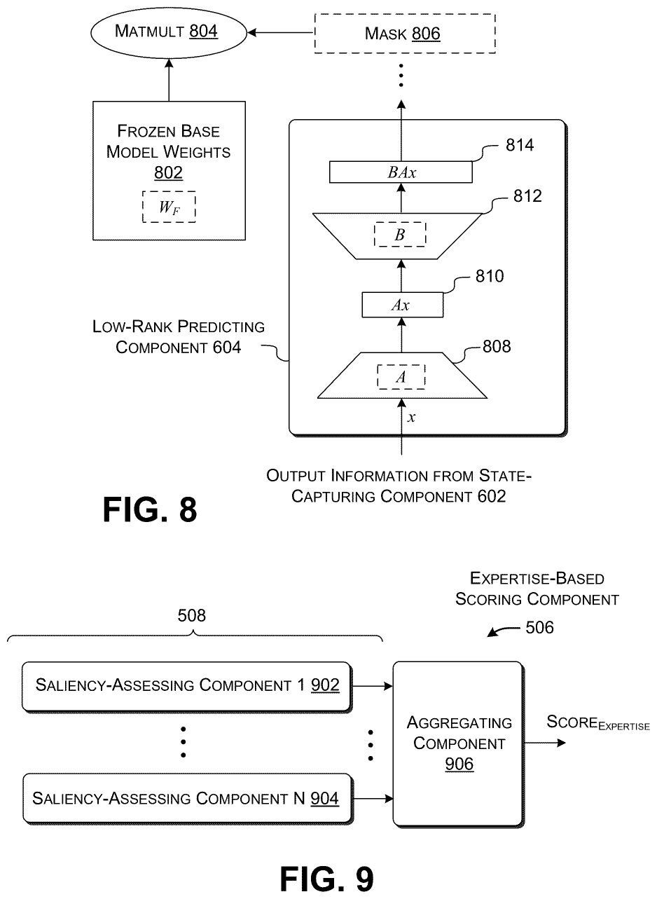

FIG. 8 shows a LoRA-based approach for producing the low-rank predicting component 604 shown in FIG. 6. Assume that the original model 104 includes a model part having base model weights 802. For example, the base model weights 802 includes a weight matrix W_{F} that governs a matrix multiplication operation 804. The low-rank predicting component 604 produces a score (Scoreₜₒₖₑₙ) which contributes to the production of a mask 806, which, in turn, influences the matrix multiplication 804, e.g., by zeroing out certain parts of the product. In some implementations, the fine-tuning component 116 trains the weights of the low-rank predicting component 604 while holding the base model weights 802 fixed.

More specifically, the weights of the low-rank predicting component 604 include weight matrices A and B. A first feed-forward layer 808 multiplies the weights A by input information x, to produce a first result Ax 810. (Note that the input information x shown in FIG. 6 actually represents the output information y produced by the state-capturing component 602, but is represented as x in the context of FIG. 8 because it now serves as input information.) A second feed-forward layer 812 multiplies the weights B by the first result Ax 810, to produce a second result BAx 814. The weight matrix A is randomly initialized at the start of a training operation. The weight matrix B is set to zero at the beginning of the training operation.

Assume that the weight matrix W_{F} of the base model weights 802 has dimensions of d×k, while the weight matrix A has the dimensions of r×k and the matrix B has the dimensions of d×r. The multiplication of matrix A by matrix B therefore yields a matrix having the same size as the matrix W_{F}. The symbol r refers to the rank. Rank r is typically much smaller than d or k (e.g., r<<min(d, k)). As such, there are much fewer weights to learn in the matrices A and B compared to the weights in the base matrix W_{F}. The low-rank predicting component 604 is considered to have low rank because it applies the weight matrices (A, B) of reduced dimensionality compared to the base model weights 802.

FIG. 7 shows one implementation of expertise-based scoring component 506 that produces the second score part (Scoreₑₓₚₑᵣₜᵢₛₑ) in the scoring component 502 of FIG. 5. The saliency-assessing components 508 include plural saliency-assessing components (902, 904) that determine the saliency (e.g., importance) of each candidate subnetwork in different respective ways. An aggregating component 906 combines the output results of the saliency-assessing components 508 using the following equation:

$${Score}_{expertise} = {\sum }_{i = 1} {w}_{i} {proxy}_{i} ( W , ∇ f ( W ) ) . \qquad ( 4 )$$

In this equation, proxyᵢ refers to a particular technique used by the saliency-accessing components 508, wᵢ is a weighting coefficient that determines how much weight is given to the particular technique, W refers to a set of parameters under consideration, and ∇ƒ(W) refers to gradients produced in a training process based on the set of parameters W and an objective function ƒ(·). Note, however, that not every saliency-assessing component relies on gradient-based information.

The following describes representative saliency-assessing components.

Magnitude. One of the saliency-assessing components 508 generates an output result based on some aggregation or selection of the magnitudes of the parameters in a parameter group. For example, this aggregation involves computing the L2 norm of the magnitudes of parameters. The saliency-determining component may optionally normalize the L2 norm based on a consideration of the L2 norms of all of the other node groups.

Average magnitude. Another of the saliency-assessing components 508 generates an output result that measures the average magnitude within a parameter group. This metric is useful to prevent the size of a group from biasing the assessment of its saliency.

Cosine Similarity. Another of the saliency-assessing components 508 generates an output result that measures the cosine similarity between a group of parameters and a gradient direction of the objective function ƒ(x) applied in training. This measure can be expressed as

$${{[ x ]}_{g}^{T} [ ∇ f ( x ) ]}_{g} / ( ‖ {[ x ]}_{g} ‖ ‖ {[ ∇ f ( x ) ]}_{g} ‖ ) ,$$

where g represents a parameter group, x represents a learnable parameter in the parameter group, T denotes transposition, ∥·∥ represents the vector norm, and ∇ is the gradient.

Taylor Series. Another of the saliency-assessing components 508 generates an output result that relies on the Taylor expansion to approximate the effects on the objective function of projecting a parameter group to zero. Various orders of the Taylor expansion are particularly useful in estimating the effects of small changes in the parameters on the objective function. The first-order Taylor expansion is expressible as the dot product of the gradient of the objective function and the change in parameters

$$( \vert {{[ x ]}_{g}^{T} [ ∇ f ( x ) ]}_{g} \vert ) ,$$

which provides a linear approximation of the objective function around a current parameter point. The second-order Taylor expansion captures the curvature of the objective function using the second derivative of the objective function

$$( {{[ x ]}_{g}^{T} [ ∇ f ( x ) ]}_{g} + {{{\frac{1}{2} [ x ]}_{g}^{T} [ {∇}^{2} f ( x ) ]}_{g} [ x ]}_{g} ) ,$$

and may be expressed using the Hessian matrix.

The above saliency measures are set forth by way of illustration, not limitation. Other implementations use one or more other metrics to assess the importance of each parameter group and/or omit one or more of the metrics described above. For example, the saliency-assessing components 508 can rely on any combination of saliency measures used in pruning, e.g., as summarized in Persand, et al., “Taxonomy of Saliency Metrics for Channel Pruning,” arXiv, arXiv: 1906.04675v2 [cs.LG], Jul. 4, 2021, 17 pages. Generally, saliency measures may rely on various formulations of weight magnitudes, activations (e.g., output feature maps), gradient-based information, etc., or any combination thereof.

Note that saliency measures that rely on the gradients produced in training are not applicable to the inference stage (assuming that no training is performed in the inference stage). As such, the inference system 108 may rely on just the training-free metrics, such as the magnitude and average magnitude saliency measures.

In conclusion to Sections A and B, the MoE model 106 produced by the MoE-generating system 102 offers improved latency and reduced resource consumption in inference relative to MOE models produced by other techniques. The MoE model 106 is efficient, in part, because it routes among entire subnetworks of the original model 104, rather than individual neurons (as is the case with other MoE strategies). Further, the MoE model is latency-efficient and resource-efficient due to its use of the low-rank predicting component 604. In contrast, some other MoE strategies rely on a slower and more resource-intensive hashing operation to choose among individual neurons. The MoE model 106 is also smaller than other MoE models 106, and therefore requires less storage space to store. These factors also expand the types of devices that are capable of feasibly running the MoE model 106.

The routing mechanism used by the MoE model is also more accurate compared to other models. The accuracy of the routing mechanism originates, in part, from its consideration of both the token-related hidden state information and the importance of individual subnetworks, which leads to a more informed selection among subnetworks compared to other models.

### C. Illustrative Process of Generating Parameter Groups

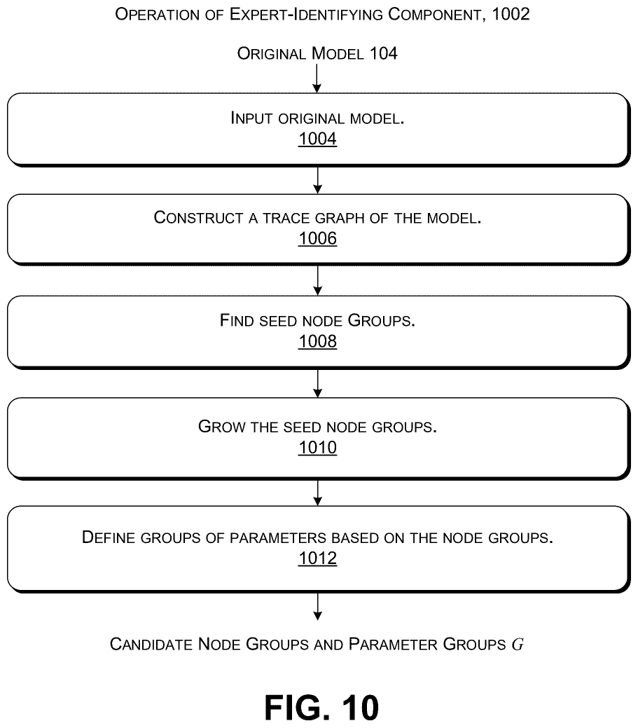

FIG. 10 shows a process 1002 performed by the expert-identifying component 112 of FIG. 1, the purpose of which is to identify node groups and associated parameter groups. In some implementations, the process 1002 is fully automated. In other implementations, the 1002 is semi-automated. More generally, the process 1002 is illustrative. In other implementations, the MoE-generating system 102 receives an identification of parameter groups produced by other algorithms. Alternatively, or in addition, a developer or other entity may manually specify the node groups and parameter groups.

The particular process 1002 of FIG. 10 identifies zero-invariant structures in the original model 104. As previously explained, a zero-invariant structure is a structure that produces zero outputs to a following layer upon setting the trainable parameters of the structure to zero. Further, minimal zero-invariant structures are chosen, meaning that each such structure cannot be further decomposed into smaller structures that satisfy the above constraint.

In block 1004, the expert-identifying component 112 receives the original model 104. In block 1006, the expert-identifying component 112 constructs a trace graph (E,V) of the original model 104. A trace graph is a kind of directed graph that includes vertices V that represent respective components in the original model 104 and edges E that represent connections among the components. In some implementations, the vertices include stem vertices, accessory vertices, and unknown vertices. Stem vertices include trainable parameters that are capable transforming input tensors into output information having other shapes. Examples of stem vertices—which typically include most of the vertices in the trace graph-include convolutional layers and linear layers of the original model 104. Joint vertices establish the connections among different vertices. For instance, joint vertices perform the function of aggregating plural input tensors into a single instance of output information. Examples of joint vertices include add, multiply, and concatenation layers of the original model 104. Accessory vertices transform a single input tensor into a single instance of output information. Examples of accessory vertices include batch normalization layers and ReLU activation layers of the original model 104. Unknown vertices perform other functions that are not known to the process 1002 in advance.

A joint vertex is said to be input shape dependent (SD) if the vertex requires that its inputs have the same shape. Otherwise, the joint vertex is said to be shape-independent (SID). An example of a shape-dependent joint vertex is an add layer. An example of a shape-independent joint vertex is a concatenation operation.

In block 1008, the expert-identifying component 112 identifies accessory vertices, SD joint vertices, and unknown vertices in the model. Block 1008 further connects adjacent vertices associated with any of these types. For example, this operation will connect two adjacent accessory vertices under the premise that these two vertices are subject to the same ancestral stem vertices, if any. This operation yields an initial set of components, which serve as skeletons for subsequent expansion.

In block 1010, the expert-identifying component 112 grows the initial set of components into connected structures until all of the incoming vertices are either stem or SID joint vertices. This produces node groups. There may be intersections among connected structures. If so, the expert-identifying component 112 merges the intersecting connected structures.

In block 1012, the expert-identifying component 112 partitions the trainable parameters into parameter groups, as guided by the node groups. In some implementations, block 1012 begins by grouping together the trainable parameters across all individual stem vertices associated with the same node group. Then, block 1012 adds the trainable parameters of accessory vertices into the groups of their dependent stem vertices. In certain cases, an accessory vertex depends on multiple groups, and, as such, the trainable parameters of this accessory vertex are added to its associated groups. This operation, where it applies, has the effect of amending the boundaries of what are considered node groups to include selected parameters of accessory vertices.

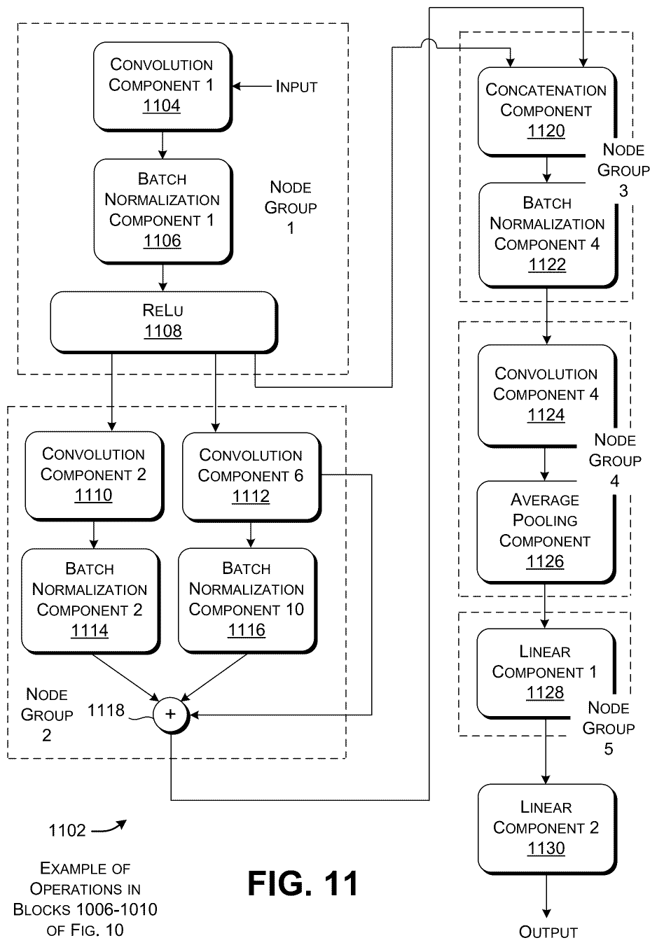

FIG. 11 shows an example of the operation of blocks 1006-1010 of FIG. 10, performed with respect to an original model 1102. The original model 1102 is a multilevel neural network having various components 1104-1130, including convolutional components (1104, 1110, 1112, and 1124), batch normalization components (1106, 1114, 1116, 1122), linear components (1128, 1130), an ReLU (rectifier linear unit) component 1108, a summation component 1118, an average pooling component 1126, and a concatenation component 1120. The summation component 1118 receives inputs from the batch normalization component 1114, the batch normalization component 1116, and the convolutional component 1112. The concatenation component 1120 receives inputs from the ReLU component 1108 and the summation component 1118.

In block 1008, the expert-identifying component 112 identifies accessory vertices, shape-dependent joint vertices, and unknown vertices, which serve as the skeletons for forming node groups. In the context of FIG. 11, these vertices include the batch normalization components (1106, 1114, 1116, 1122), the ReLU component 1108, the summation component 1118, and the average pooling component 1126. In block 1010, the expert-identifying component 112 expands these seed components into nodes groups 1-5. For instance, the expert-identifying component 112 establishes that the stem vertex associated with convolutional component 1104 is affiliated with the accessory vertex for the batch normalization component 1106 and the ReLU component 1108. It also establishes that the stem vertices associated with the convolutional components (1110, 612) are affiliated with the accessory vertices for the batch normalization components (1114, 1116).

The linear component 1130 delivers the final output of the original model 1102. It has a fixed output which is not affiliated with any node group. Further, although not the case for the original model 1102 of FIG. 11, the expert-identifying component 112 does not integrate an unknown vertex into any node group, for reasons of safety.

### D. Illustrative Fine-Tuning Process

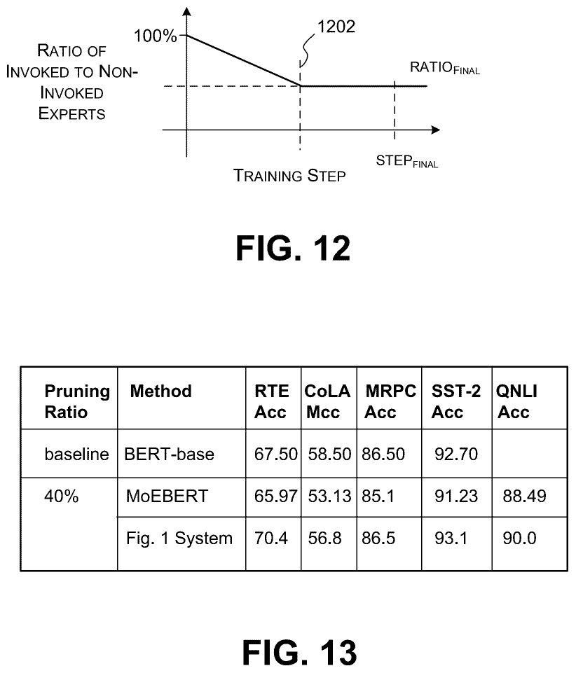

FIG. 12 shows a principle that governs operation of a fine-tuning component 116 of FIG. 1. As indicated there, the fine-tuning component 116 gradually decreases the percentage of experts it invokes from an initial value (e.g., 100 percent) to a target value (Ratio), once a prescribed percentage of the training steps have been completed. This has the effect of smoothly increasing the role of the routers in the MoE model 106 as training proceeds. This process is based on the premise that training will be most effective if the routers are slowly and incrementally taught how to successfully choose subsets of subnetworks.

In some implementations, a ratio variable is changed during training based on the following Equation:

$$ratio = \{ \begin{matrix}1 - \frac{1 - Ratio}{p ⋆ S} ⋆ s & if s < p ⋆ S \\ Ratio & otherwise\end{matrix} . \qquad ( 5 )$$

In this equation, p is the portion of warm-up steps in which the ratio value is decreased until reaching the final value Ratio at a step 1202, S is the total number of training steps, and s is the current training step. As previously stated, a single Ratio parameter applies to all MoE components in the MoE model 106, or different Ratio parameters apply to different respective MoE components. In the latter implementation, different instantiations of Equation (5) apply to different respective MoE components.

In addition, or alternatively, the fine-tuning component 116 treats the coefficient α used in Equation (2) as a trainable parameter that is updated along with the other parameters of the routers. By doing so, the fine-tuning component 116 is able to quickly find a local optimal value for this coefficient, as opposed, for instance, to performing an extensive and computationally expensive search over a parameter space. Alternatively, or in addition, the hyper-parameter K is treated as a trainable parameter.

### E. Illustrative Performance

FIG. 13 shows a chart that summarizes the performance of the MoE model 106 produced by the MoE-generating system 102 of FIG. 1 (which is identified in the chart as the “FIG. 1 System”). The performance of the MoE model 106 is specifically compared with a BERT model that does not use expert selection (identified as “BERT-base” in the chart) and another mixture-of-experts strategy described in Zuo, et al., “MoEBERT: from BERT to Mixture-of-Experts via Importance-Guided Adaptation,” arXiv, arXiv: 2204.07675v2 [cs.CL], Apr. 28, 2022, 14 pages (identified in the chart as “MoEBERT”). Recognizing Textual Entailment (RTE), Corpus of Linguistic Acceptability (CoLA), Microsoft Research Paraphrase Corpus (MRPC), Stanford Sentiment Treebank (SST-2), and Question-answering Natural Language Inference (QNLI) refer to different publicly available training corpuses that are used to train different version of the models. “Acc” measures an extent to which a model produces correct predictions for both positive training examples and negative training examples. “MCC” refers to Matthew's Correlation Coefficient, which measures binary classification quality. “Pruning Ratio” is the Ratio parameter used in Equation (4). In this test, Ratio is set to 40 percent.

The chart illustrates that the MoE model 106 of FIG. 1 (“FIG. 1 System”) produces output responses having accuracy that is better than or comparable to those produced by the BERT-base and MoEBERT models. The MoE model 106 of FIG. 1 is also more resource efficient than the MoEBERT model because it routes among entire subnetworks using a low-rank predicting component 604, whereas the MoEBERT model activates individual neurons using a computationally expensive hashing algorithm. The MoE-generating system 102 also trains the MoE model 106 in a more computationally efficient manner than the training that produces the MoEBERT model.

### F. Illustrative Processes

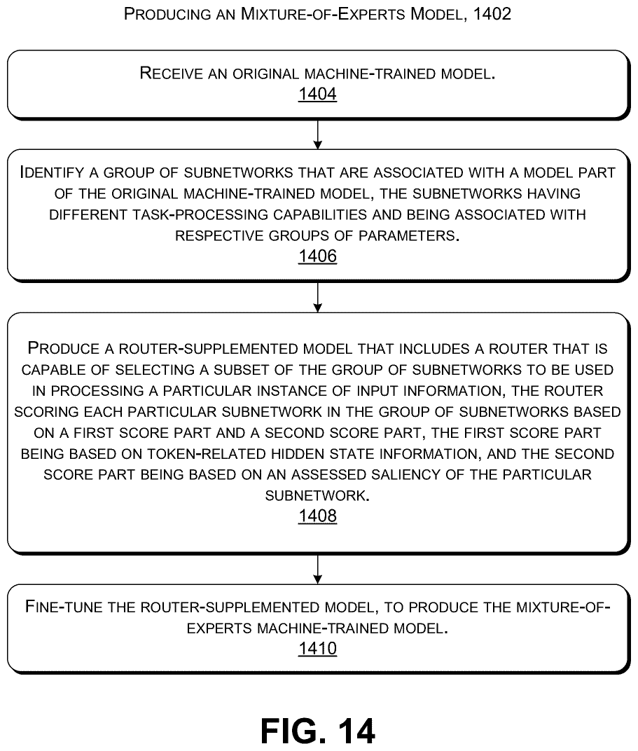

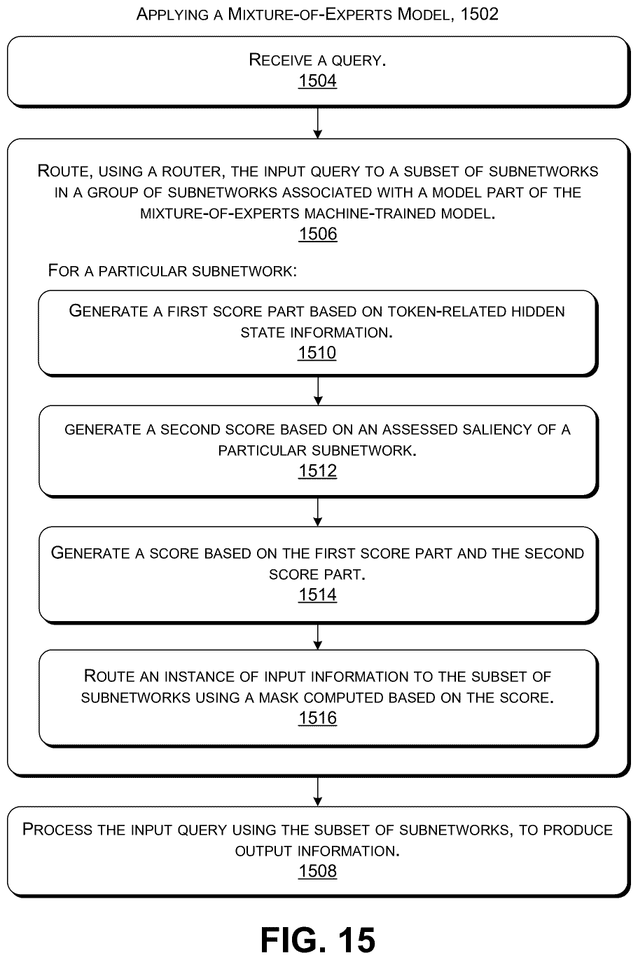

FIGS. 14 and 15 show two processes that represent an overview of the operation of the MoE-generating system 102 and the inference system 108 of FIG. 1, respectively. Each of the processes is expressed as a series of operations performed in a particular order. But the order of these operations is merely representative, and the operations are capable of being varied in other implementations. Further, any two or more operations described below are capable of being performed in a parallel manner. In one implementation, the blocks shown in the processes that pertain to processing-related functions are implemented by the computing equipment described in connection with FIGS. 16 and 17.

More specifically, FIG. 14 shows a process 1402 for transforming an original machine-trained model (e.g., the original machine-trained model 104) into a mixture-of-experts machine-trained model (e.g., the MoE model 106). In block 1404, the MoE-generating system 102 receives the original machine-trained model. In block 1406, the MoE-generating system 102 identifies a group of subnetworks (e.g., corresponding to the first node group 314) that are associated with a model part of the original machine-trained model. The subnetworks have different task-processing capabilities and are associated with respective groups of parameters. In block 1408, the MoE-generating system 102 produces a router-supplemented model by producing a router (e.g., the router 404) that is capable of selecting a subset of the group of subnetworks to be used in processing a particular instance of input information. The router scores each particular subnetwork in the group of subnetworks based on a first score part and a second score part. The first score part is based on token-related hidden state information, and the second score part is based on an assessed saliency of the particular subnetwork. In block 1410, the MoE-generating system 102 fine-tunes the router-supplemented model, to produce the mixture-of-experts machine-trained model.

FIG. 15 shows a process 1502 for processing an input query using a mixture-of-experts machine-trained model (e.g., the MoE model 106). In block 1504, the inference system 108 receives the input query. In block 1506, the inference system 108 routes, using a router (e.g., the router 404), the input query to a subset of subnetworks in a group of subnetworks (e.g., corresponding to the first node group 314) associated with a model part of the mixture-of-experts machine-trained model. In block 1508, the inference system 108 processes the input query using the subset of subnetworks, to produce output information.

The routing includes, for each particular subnetwork in the group of subnetworks, the operations in blocks 1510-1516. That is, in block 1510, the inference system 108 generates a first score part based on token-related hidden state information. In block 1512, the inference system 108 generates a second score part based on an assessed saliency of the particular subnetwork. In block 1514, the inference system 108 generates a score based on the first score part and the second score part. In block 1516, the inference system 108 routes an instance of input information to the subset of subnetworks using a mask computed based on the score.

### G. Illustrating Computing Devices

FIG. 16 shows computing equipment 1602 that, in some implementations, is used to implement the MoE-generating system 102 and the inference system 108. The computing equipment 1602 includes a set of local devices 1604 coupled to a set of servers 1606 via a computer network 1608. Each local device corresponds to any type of computing device, including any of a desktop computing device, a laptop computing device, a handheld computing device of any type (e.g., a smartphone or a tablet-type computing device), an extended reality device, an intelligent appliance, a wearable computing device (e.g., a smart watch), an Internet-of-Things (IoT) device, a gaming system, a media device, a vehicle-borne computing system, any type of robot computing system, etc. In some implementations, the computer network 1608 is implemented as a local area network, a wide area network (e.g., the Internet), one or more point-to-point links, or any combination thereof.

The bottom-most overlapping box in FIG. 16 indicates that the functionality of the MoE-generating system 102 and the inference system 108 is capable of being spread across the local devices 1604 and/or the servers 1606 in any manner. Section A provides examples of different allocations of the functionality with respect to the MoE-generating system 102. The same possibilities apply to the inference system 108.

FIG. 17 shows a computing system 1702 that, in some implementations, is used to implement any aspect of the mechanisms set forth in the above-described figures. For instance, in some implementations, the type of computing system 1702 shown in FIG. 17 is used to implement any local computing device or any server shown in FIG. 16. In all cases, the computing system 1702 represents a physical and tangible processing mechanism.

The computing system 1702 includes a processing system 1704 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1702 also includes computer-readable storage media 1706, corresponding to one or more computer-readable media hardware units. The computer-readable storage media 1706 retains any kind of information 1708, such as machine-readable instructions, settings, model weights, and/or other data. In some implementations, the computer-readable storage media 1706 includes one or more solid-state devices, one or more hard disks, one or more optical disks, etc. Any instance of the computer-readable storage media 1706 represents a fixed or removable unit of the computing system 1702. Further, any instance of the computer-readable storage media 1706 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 1702 utilizes any instance of the computer-readable storage media 1706 in different ways. For example, in some implementations, any instance of the computer-readable storage media 1706 represents a hardware memory unit (such as random access memory (RAM)) for storing information during execution of a program by the computing system 1702, and/or a hardware storage unit (such as a hard disk) for retaining/archiving information on a more permanent basis. In the latter case, the computing system 1702 also includes one or more drive mechanisms 1710 (such as a hard drive mechanism) for storing and retrieving information from an instance of the computer-readable storage media 1706.

In some implementations, the computing system 1702 performs any of the functions described above when the processing system 1704 executes computer-readable instructions stored in any instance of the computer-readable storage media 1706. For instance, in some implementations, the computing system 1702 carries out computer-readable instructions to perform each block of the processes described with reference to FIGS. 14 and 15. FIG. 17 generally indicates that hardware logic circuitry 1712 includes any combination of the processing system 1704 and the computer-readable storage media 1706.

In addition, or alternatively, the processing system 1704 includes one or more other configurable logic units that perform operations using a collection of logic gates, such as field-programmable gate arrays (FPGAs), etc. In these implementations, the processing system 1704 effectively incorporates a storage device that stores computer-readable instructions, insofar as the configurable logic units are configured to execute the instructions and therefore embody or store these instructions.

In some cases (e.g., in the case in which the computing system 1702 represents a user computing device), the computing system 1702 also includes an input/output interface 1714 for receiving various inputs (via input devices 1716), and for providing various outputs (via output devices 1718). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1720 and an associated graphical user interface presentation (GUI) 1722. The display device 1720 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1702 also includes one or more network interfaces 1724 for exchanging data with other devices via one or more communication conduits 1726. One or more communication buses 1728 communicatively couple the above-described units together.

The communication conduit(s) 1726 is implemented in any manner, e.g., by a local area computer network, a wide area computer network (e.g., the Internet), point-to-point connections, or any combination thereof. The communication conduit(s) 1726 include any combination of hardwired links, wireless links, routers, gateway functionality, name servers, etc., governed by any protocol or combination of protocols.

FIG. 17 shows the computing system 1702 as being composed of a discrete collection of separate units. In some cases, the collection of units corresponds to discrete hardware units provided in a computing device chassis having any form factor. FIG. 17 shows illustrative form factors in its bottom portion. In other cases, the computing system 1702 includes a hardware logic unit that integrates the functions of two or more of the units shown in FIG. 17. For instance, in some implementations, the computing system 1702 includes a system on a chip (SoC or SOC), corresponding to an integrated circuit that combines the functions of two or more of the units shown in FIG. 17.

The following summary provides a set of illustrative examples of the technology set forth herein.

(A1) According to one aspect, a method (e.g., the process 1402) is described for transforming an original machine-trained model (e.g., the original model 104) into a mixture-of-experts machine-trained model (e.g., the model 106). In block 1404, the MoE-generating system 102 receives the original machine-trained model. In block 1406, the MoE-generating system 102 identifies a group of subnetworks that are associated with a model part of the original machine-trained model, the subnetworks having different task-processing capabilities and being associated with respective groups of parameters. In block 1408, the MoE-generating system 102 produces a router-supplemented model including a router (e.g., the router 402) that is capable of selecting a subset of the group of subnetworks to be used in processing a particular instance of input information. The router scores each particular subnetwork in the group of subnetworks based on a first score part and a second score part. The first score part is based on token-related hidden state information, and the second score part is based on an assessed saliency of the particular subnetwork. In block 1410, the MoE-generating system 102 fine-tunes the router-supplemented model, to produce the mixture-of-experts machine-trained model.

(A2) According to some implementations of the method of A1, the identifying and producing provides plural groups of subnetworks that are served by respective routers.

(A3) According to some implementations of the methods of A1 or A2, the identifying includes: producing a directed graph that represents connections among components in the original machine-trained model, the components being associated with respective nodes in the directed graph, and the connections being associated with respective edges in the directed graph; and identifying a group of nodes in the directed graph that are associated with the model part. The groups of parameters are associated with the group of nodes.

(A4) According to some implementations of any of the methods of A1-A3, the identifying includes identifying removal subnetworks that are capable of being removed without affecting functions performed by remaining subnetworks of the original machine-trained model.

(A5) According to some implementations of the method of A4, the removal subnetworks are minimal removal subnetworks, each of the minimal removal subnetworks being incapable of being further decomposed into smaller removal subnetworks.

(A6) According to some implementations of the methods of A4 or A5, the removal subnetworks are associated with zero-invariant groups of parameters, a zero-invariant group of parameters having a property that, when parameters of the zero-invariant-group of parameters are set to zero, a component of the original-machine-trained model that uses the zero-invariant group of parameters will produce an output result that is also zero.

(A7) According to some implementations of any of the methods of A1-A6, the router produces a score that is a weighted combination of the first score part and the second score part.

(A8) According to some implementations of any of the methods of A1-A7, the first score part is produced by: generating an instance of output information based on the token-related hidden state information, the token-related hidden state information encapsulating information about token positions and values encountered in previous states; and mapping the instance of output information into the first score part using a prediction neural network.

(A9) According to some implementations of the method of A8, the prediction neural network combines weight matrices of prescribed dimensionalities to produce a weight matrix having a larger dimensionality than either of the prescribed dimensionalities.

(A10) According to some implementations of any of the methods of A1-A9, the second score part is produced based on an aggregation of plural saliency measures that describe the saliency of the particular subnetwork in different respective ways.

(A11) According to some implementations of any of the methods of A1-A10, the router produces a score that is a weighted combination of the first score part and the second score part, and wherein the router selects the subset of subnetworks by: generating a mask based on the score; and applying the mask to the group of subnetworks, resulting in removing contributions of unselected subnetworks.

(A12) According to some implementations of any of the methods of A1-A11, the fine-tuning involves successively increasing use of the router as training proceeds.

(A13) According to some implementations of any of the methods of A1-A12, the router produces a score that is a weighted combination of the first score part and the second score part, and wherein the fine-tuning involves training hyper-parameter information that governs how the first score part is weighted relative to the second score part.

(A14) According to some implementations of any of the methods of A1-A13, the fine-tuning involves adjusting values of parameters associated with the router while holding parameters associated with the original machine-trained model constant.

(B1) According to another aspect, a method (e.g., the process 1502) is described for processing an input query using a mixture-of-experts machine-trained model (e.g., the MoE model 106). In block 1504, the inference system 108 receives the input query. In block 1506, the inference system 108 routes, using a router (e.g., the router 402), the input query to a subset of subnetworks in a group of subnetworks associated with a model part of the mixture-of-experts machine-trained model. In block 1508, the inference system 108 processes the input query using the subset of subnetworks, to produce output information.

The routing operation of block 1506 includes, for each particular subnetwork in the group of subnetworks, the following operations. In block 1510, the inference system 108 generates a first score part based on token-related hidden state information. In block 1512, the inference system 108 generates a second score based on an assessed saliency of the particular subnetwork. In block 1514, the inference system 108 generates a score based on the first score part and the second score part. In block 1514, the inference system 108 routes an instance of input information to the subset of subnetworks using a mask computed based on the score.

In yet another aspect, some implementations of the technology described herein include a computing system (e.g., the computing system 1702) that includes a processing system (e.g., the processing system 1704) having a processor. The computing system also includes a storage device (e.g., the computer-readable storage media 1706) for storing computer-readable instructions (e.g., the information 1708). The processing system executes the computer-readable instructions to perform any of the methods described herein (e.g., any individual method of the methods of A1-A14 or B1).

In yet another aspect, some implementations of the technology described herein include a computer-readable storage medium (e.g., the computer-readable storage media 1706) for storing computer-readable instructions (e.g., the information 1708). A processing system (e.g., the processing system 1704) executes the computer-readable instructions to perform any of the operations described herein (e.g., the operations in any individual method of the methods of A1-A14 or B1).

In yet another aspect, some implementations of the technology described herein include a computing system or computer-readable storage medium for providing a mixture-of-experts model produced by any of the methods of A1-A4.

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 1712 of FIG. 15. The term “logic” likewise encompasses various physical and tangible mechanisms for performing a task. For instance, each processing-related operation illustrated in the flowcharts of FIGS. 14 and 15 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for transforming an original machine-trained model into a mixture-of-experts machine-trained model, comprising:
receiving the original machine-trained model;
identifying a group of subnetworks that are associated with a model part of the original machine-trained model, the subnetworks having different task-processing capabilities and being associated with respective groups of parameters;
producing a router-supplemented model that includes a router that is capable of selecting a subset of the group of subnetworks to be used in processing a particular instance of input information,
the router scoring each particular subnetwork in the group of subnetworks based on a first score part and a second score part, the first score part being based on token-related hidden state information, and the second score part being based on an assessed saliency of the particular subnetwork; and
fine-tuning the router-supplemented model, to produce the mixture-of-experts machine-trained model.

2. The method of claim 1, wherein the identifying and producing provides plural groups of subnetworks that are served by respective routers.

3. The method of claim 1, wherein the identifying includes:
producing a directed graph that represents connections among components in the original machine-trained model, the components being associated with respective nodes in the directed graph, and the connections being associated with respective edges in the directed graph; and
identifying a group of nodes in the directed graph that are associated with the model part,
the groups of parameters being associated with the group of nodes.

4. The method of claim 1, wherein the identifying includes identifying removal subnetworks that are capable of being removed without affecting functions performed by remaining subnetworks of the original machine-trained model.

5. The method of claim 4, wherein the removal subnetworks are minimal removal subnetworks, each of the minimal removal subnetworks being incapable of being further decomposed into smaller removal subnetworks.

6. The method of claim 4, wherein the removal subnetworks are associated with zero-invariant groups of parameters, a zero-invariant group of parameters having a property that, when parameters of the zero-invariant-group of parameters are set to zero, a component of the original-machine-trained model that uses the zero-invariant group of parameters will produce an output result that is also zero.

7. The method of claim 1, wherein router produces a score that is a weighted combination of the first score part and the second score part.

8. The method of claim 1, wherein the first score part is produced by:
generating an instance of output information based on the token-related hidden state information, the token-related hidden state information encapsulating information about token positions and values encountered in previous states; and
mapping the instance of output information into the first score part using a prediction neural network.

9. The method of claim 8, wherein the prediction neural network combines weight matrices of prescribed dimensionalities to produce a weight matrix having a larger dimensionality than either of the prescribed dimensionalities.

10. The method of claim 1, wherein the second score part is produced based on an aggregation of plural saliency measures that describe the saliency of the particular subnetwork in different respective ways.

11. The method of claim 1, wherein router produces a score that is a weighted combination of the first score part and the second score part, and wherein the router selects the subset of subnetworks by:
generating a mask based on the score; and
applying the mask to the group of subnetworks, resulting in removing contributions of unselected subnetworks.

12. The method of claim 1, wherein the fine-tuning involves successively increasing use of the router as training proceeds.

13. The method of claim 1, wherein the router produces a score that is a weighted combination of the first score part and the second score part, and wherein the fine-tuning involves training hyper-parameter information that governs how the first score part is weighted relative to the second score part.

14. The method of claim 1, wherein the fine-tuning involves adjusting values of parameters associated with the router while holding parameters associated with the original machine-trained model constant.

15. A computing system for processing an input query using a mixture-of-experts machine-trained model, comprising:
an instruction data store for storing computer-readable instructions; and
a processing system for executing the computer-readable instructions in the data store, to perform operations including:
receiving the input query;
routing, using a router, the input query to a subset of subnetworks in a group of subnetworks associated with a model part of the mixture-of-experts machine-trained model; and
processing the input query using the subset of subnetworks, to produce output information,
the routing including, for each particular subnetwork in the group of subnetworks:
generating a first score part based on token-related hidden state information;
generating a second score based on an assessed saliency of the particular subnetwork;
generating a score based on the first score part and the second score part; and
routing an instance of input information to the subset of subnetworks using a mask computed based on the score.

16. The computing system of claim 15, wherein the score is a weighted combination of the first score part and the second score part.

17. The computing system of claim 15, wherein the first score part is produced by:
generating an instance of output information based on the token-related hidden state information, the token-related hidden state information encapsulating information about token position and values encountered in previous states; and
mapping the instance of output information into the first score part using a prediction neural network.

18. The computing system of claim 17, wherein the prediction neural network combines weight matrices of prescribed dimensionalities to produce a weight matrix having a larger dimensionality than either of the prescribed dimensionalities.

19. The computing system of claim 15, wherein the second score part is produced based on an aggregation of plural saliency measures that measure the saliency of the particular subnetwork in different respective ways.

20. A computer-readable storage medium for storing computer-readable instructions, a processing system executing the computer-readable instructions to perform operations, the operations comprising:
receiving an identification of a group of subnetworks that are associated with a model part of an original machine-trained model, the subnetworks having different task-processing capabilities and being associated with respective groups of parameters;
producing a router-supplemented model that includes a router that is capable of selecting a subset of the group of subnetworks to be used in processing a particular instance of input information, the router scoring each particular subnetwork in the group of subnetworks based on a first score part and a second score part,
the first score part being based on token-related hidden state information, the token-related hidden state information encapsulating information about token positions and values encountered in previous states, and the second score part being based on plural assessments of saliency of the particular subnetwork produced by different respective processes; and
fine-tuning the router-supplemented model, to produce a mixture-of-experts machine-trained model.
